(19) United States
(12) Patent Application Publication
(10) Pub. No.: US 2021/0367987 A1
(43) Pub. Date: Nov. 25, 2021

(54) Live Broadcast Network Using Musical Encoding to Deliver Solo, Group or Collaborative Performances

(71) Applicant: David Kent, Isleton, CA (US)

(72) Inventor: David Kent, Isleton, CA (US)

(21) Appl. No.: 15/929,829

(22) Filed: May 24, 2020

(51) Int. Cl. H04L 29/06

(52) U.S. Cl. CPC H04L 65/4076

(57) ABSTRACT

A broadcast network designed to deliver a unique musical experience for consumers by receiving and processing elemental musical events that accurately describe an artist's performance or composition but contain no information about the actual sound or light at the originating location, and broadcasting these events in the form of musical commands to a number of listeners, who each experience these performances through artificial sound and images generated at their own location.

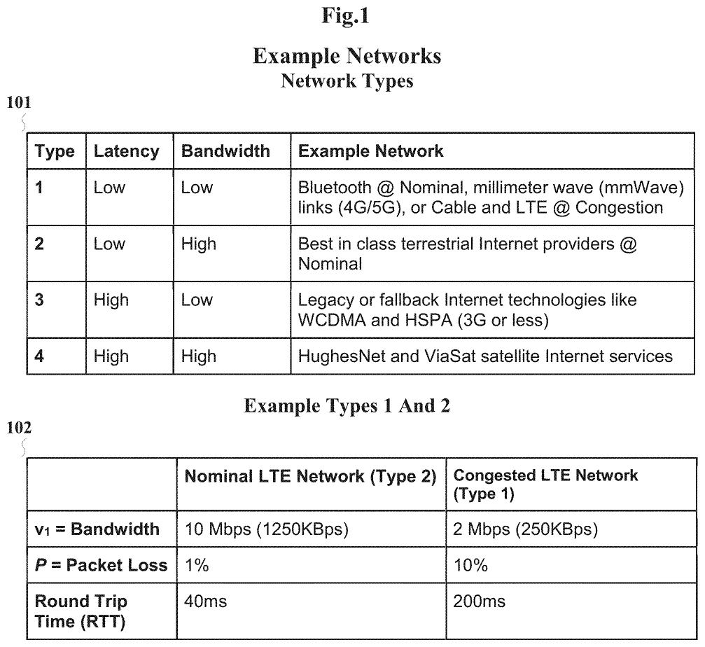

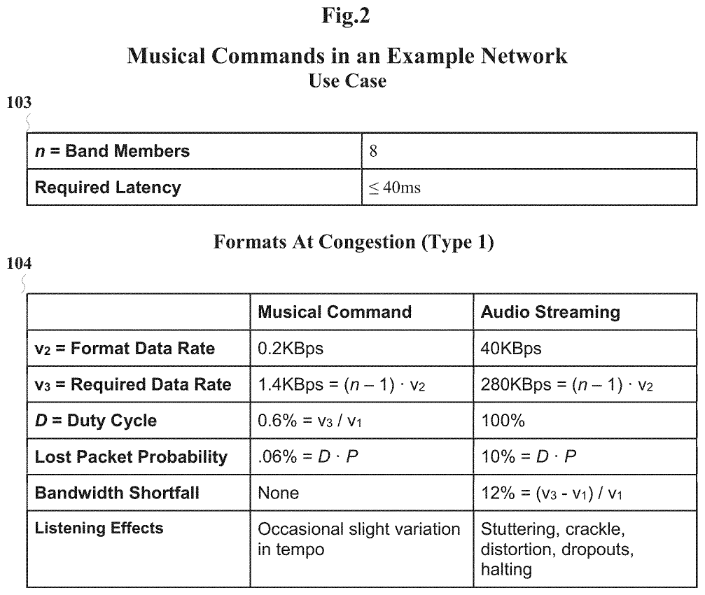

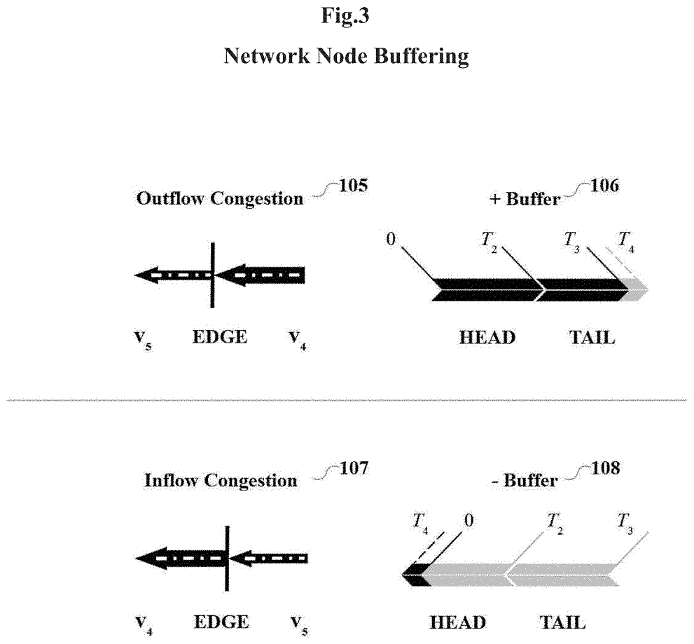

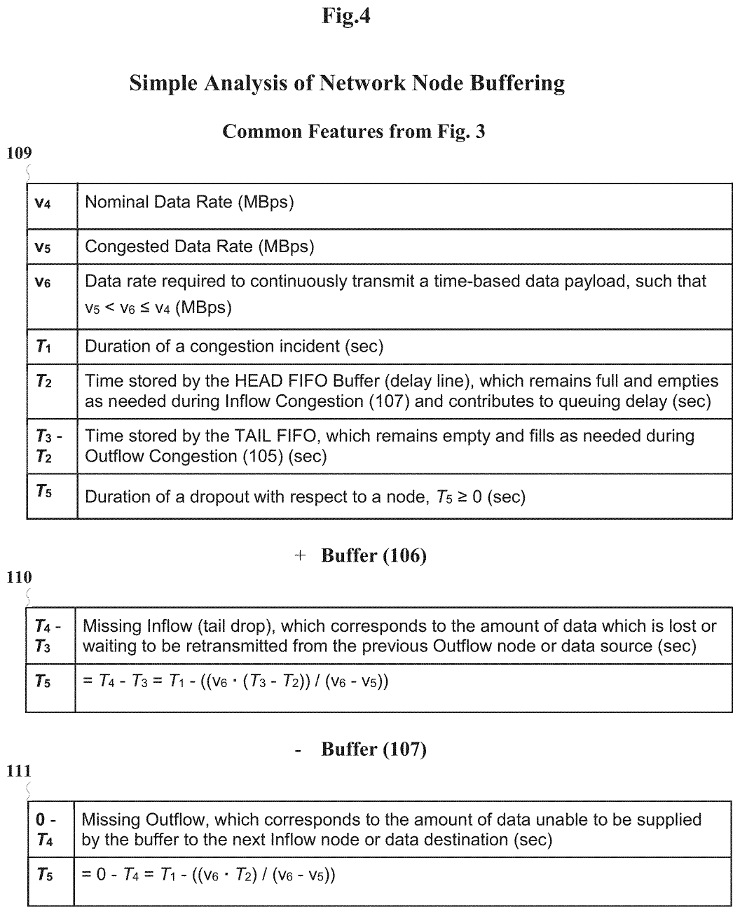

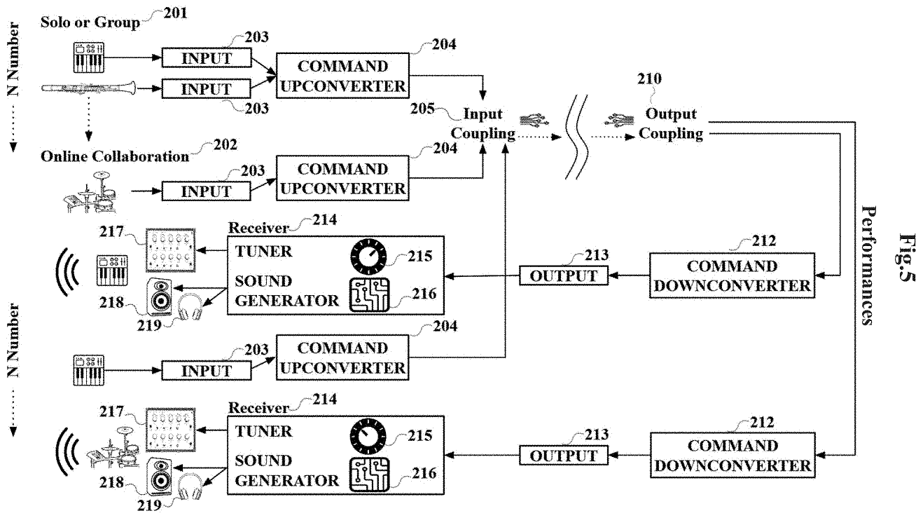

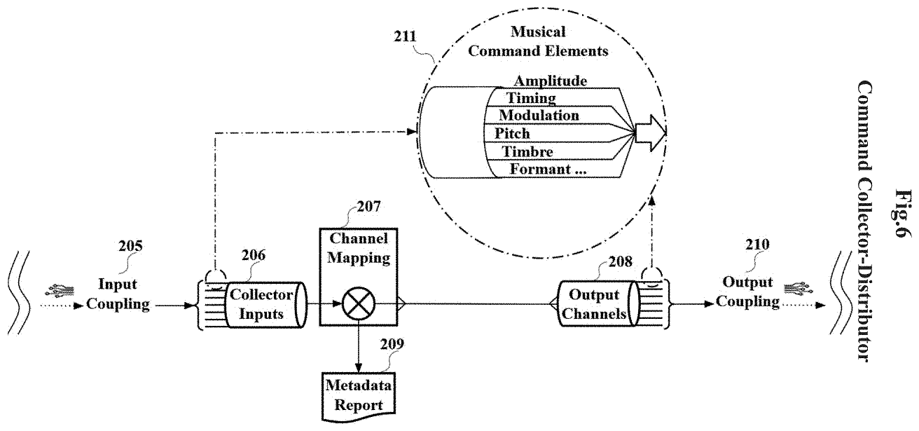

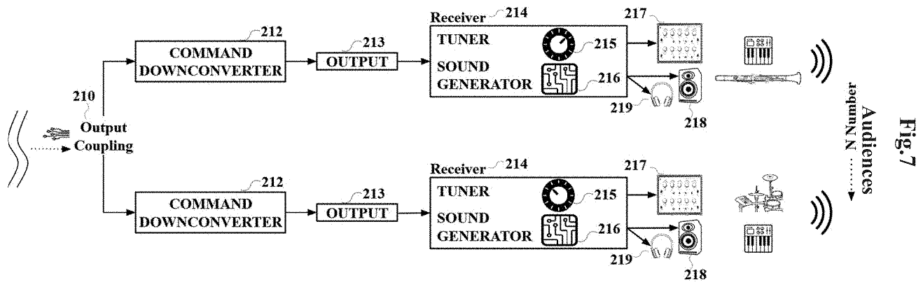

### TECHNICAL FIELD

This disclosure relates to the fields of signal conversion and broadcast communications, including but not limited to Internet communications, as is related to the distribution and reproduction of elemental musical signals, as opposed to acoustical, which may be produced by musical performers and broadcast to a remote audience where said signals are subjectively reproduced as audible and possibly visual effects. This disclosure also describes one or more embodiments that prescribe requirements for devices that are claimed as an integral part of the invention.

### BACKGROUND OF THE PRIOR ART

The transmission of information which forms the basis for communication depends on the quality of the carrying medium, such as air for the human voice. Such transmission also depends on an encoding understood by the transmitter and receiver. In the case of the human voice, they are the speaker and the listener. Most such viable encodings depend on creating and absorbing events in time. Even spoken languages create a rhythm for understanding (isochrony). Extending the distance and density of this information is a natural human motivation taking the form of such ancient inventions as drum language, war drums and more modern methods involving new mediums, such as electrical and electromagnetic propagation utilized by the telegraph. For highly compressed and lossy information, encodings such as Morse for telegraphy allow English or English-mapped alphabetic numerals to be mapped to a binary pattern parameterized by signal duration. In such encodings, it is impossible to recover specific information about the acoustics of the speaker, the handwriting of an original missive, the inflection of the speaker or other aspects of realism unless those are subsequently described into the encoded stream, such descriptions being subject to the same limitations as the message itself and compromising the efficiency of the encoding. Only by a sense of poetic interpretation can more information be speculatively received and would be subjective, based solely on the decoded contents.

With the advent of telephony, television and radio a step forward was taken but for the purposes of this invention a step was skipped. Telephone, radio and television encodings map the movement of the original medium over time, which originates as a waveform. In the case of audible signals it is the movement of air over time and in the case of visual signals it is the intensity and frequency of light (brightness and color). Compressing and encoding such waveforms into various mediums, including digitized encodings, involves the arts of information theory and signal processing, such as PCM for telephony, AM and FM for radio and NTSC for television. Even such encodings contain inaccuracies and noise to the limitations of the medium and encoding methods to keep up with the density of information over time, often causing an observer to experience an objectionable lack of realism when receiving. For example, though interpreted, the reading of a properly transmitted telegram is noise-free from the perspective of the reader and might be preferable to the same message being received over a poor radio signal. In this way, this invention is predicated on the idea that “low fidelity” encodings actually become “high fidelity” decodings if the proper method is utilized and explained to an observer.

### BACKGROUND OF THE INVENTION

For the purposes of this invention, the step that was skipped was to broaden the information density without resorting to mapping the behavior of a medium, conventionally derived from the conditions of physical reality at the source. In order to make a decoding understood to an observer the general meaning of the recovered information in lossy form must be described. For example, which is not known to have actually occurred, it would be possible to add punctuation or markup signals in parallel to telegraphy and colorize or otherwise enhance a telegram in order to convey additional information about the behavior or intention of the sender. Or, add a visual blinking light to the message stream whereby “light on” means “shouting”. In either case the encoding depth has increased but the resultant meaning must be explained. However, if a personal interpretation is allowed on the part of the observer, both fictitious examples represent a low-noise, high fidelity transmission if there is sufficient belief in the actual meaning of the result.

There is an undefined threshold at which an attempt at realism, such as by mapping changes in a medium, becomes an objectionable experience for some if insufficient or overly accurate. Yet, it is possible for a specifically dense encoding to be decoded into a sublime “high fidelity” experience if properly explained to an observer. For the purposes of this invention, a musical encoding is chosen to produce this effect.

The elements of music lend themselves well to an approximate encoding. Whereas elements such as pitch, amplitude, timbre and duration are themselves theoretical and approximate, the number of discrete parameters actually represented are few as compared to the complex interference patterns and subtleties contained in the natural behavior of physical mediums. Therefore, when such elements are encoded as signals and reproduced subjectively, with reasonably accurate adherence to the standards of pitch and time a sublime listening experience may be recreated for the listener.

### BRIEF SUMMARY OF THE INVENTION

A broadcast network designed to deliver a unique and varied musical experience for listeners by filling in the gap created when the prior art of signal encoding emerged and refined its methods to model the acoustical medium of the originating performances rather than the musical elements of the music being performed. When one or more performers play their instruments, possibly including but not limited to the human voice or other necessarily acoustic instruments, the acoustical effect is disregarded or minimally communicated with respect to the musical elements such as pitch, timbre and timing. Some instruments are already equipped to supply musical elements directly and others require available conversions that can analyze and convert acoustics into these elements. The resultant musical elements representing the performances are centrally collected and broadcast to a wide audience, located remotely, as musical signals. Many performances are made available to many listeners. The performance experience is recreated subjectively, local to each listener, once a performance is selected by a compatible device. The local synthesis lends a sense of immediacy, zero noise, and personal presence of the artist, since the synthesizer is capable of being controlled by performers in approximately real time.

### BRIEF DESCRIPTION OF THE DRAWINGS

Some preferred embodiments of the present invention are illustrated as an example and are not to be considered as limiting its scope with regard to other embodiments, which the invention is capable of implementing. Accordingly:

The Drawing depicts a modern broadcast system utilizing musical encodings to deliver solo, group and collaborative performances to remote audiences through multiway performance signal generation, input conversion, input medium coupling, centralized collection and multiway distribution, medium output coupling, output conversion, output selection and output recreation by means of localized internal or external synthesis.

### DETAILED DESCRIPTION OF THE DRAWINGS

The Drawing shows the two or more types of Performances (101, 102), each Performance presumably located within similar proximity and performed by a soloist or a group with local interaction. Some performances may require live coordination with other performances as facilitated by the system. These types of performances are referred to as Online Collaborations. Other types of performances may be envisioned as combinations or extensions of the Solo or Group Performance and Online Collaborations, such as “Play Along” with prerecorded elemental musical signals, “Remix” with replays of past performances, “Round Robin” with control being passed to each group at musically timed intervals, “Jam Session” with an ad hoc cohort, “Battle Of the Bands”, with each group being ranked by listeners, “Mash Up” with artificially synchronized juxtaposed live or recorded musical elements, “Tape Loop” with asynchronous contributions to a looping recording of fixed cycle length, and “Listener Requests” with live metadata influencing the performers. In one embodiment, Online Collaborations may conduct a musical encoding (103) through a digital network such as the Internet and couple via peer-to-peer or network edge technologies to accomplish low latency delivery.

Conversion from mechanical or acoustical manipulation to encode a performance occurs to create an Input (104). Such conversion is embedded as part of musical instrument type or musical instrument conversion and is presumed to preexist. The Input contains any viable musical encoding as may be created by playing the instrument or capturing acoustical or other signals that may be analyzed and reduced into a musical encoding. An Input drives a Converter (105) that normalizes the musical encoding and prepares it to be transmitted into a proper Input Coupling format (106) as may be recognized by the Channel Collector (107).

The feature in the drawing numbered (106) represents the Input Coupling, which is an abstract form of connectivity provided to the Channel Collector (107). In one embodiment, the Input Coupling (106) could be a hard-wired cable bundle where the musical elements are represented as low latency electrical signals conducted or multiplexed among one or more individual cables, as may be suitable for a local collective venue such as a convention or competition; in another embodiment the Input Coupling (106) could be consumer band low power modulated radio signals, as may be suitable for an outdoor venue such as a festival; in another embodiment the Input Coupling (106) could be digitized signals routed through a local area network, Intranet or Internet, as may be suitable for public broadcast.

The feature in the drawing numbered (107) represents the Channel Collector, which receives multiple musical encodings from multiple Performances through an Input Coupling (106) and makes mapping decisions based on metadata between the Performances and their corresponding Output Channels (108, 109). Such decisions for Non-Collaborative Output Channels (108), to be broadcast generally, may be based on time of day correlated to performance schedules, genre of a performance as stated by the performer or associated with their profile, popularity of a performer or memorable performance, or other criteria. Such decisions for Collaborative Output Channels (109) may be based on performers registering their intent to perform with others capable of attaching to the system, finding performers of a similar genre willing to contribute in a group of a certain size, instrumentation or notoriety, or other criteria. A representation of any or all criteria and the current state of the associated decision maps may be requested by an observer as a Metadata Report (110) from the Channel Collector (107). The Channel Collector (107) feeds all of its mapped Output Channels (108, 109) containing individual or combined musical encodings to one of two or more output groups, the ones labeled herein are the Non-Collaborative Output Channels (108) and the Collaborative Output Channels (109).

The drawing shows that Output Channels from the Channel Collector (107) are presented to an Output Coupling (110) whose possible mediums and encoding methods may vary as described by the Input Coupling (106), but not necessarily of a matching type. For example, a hard-wired Input Coupling (106) for a convention venue could result in an Internet Output Coupling (110) for public broadcast.

The inset detail numbered (103) makes it clear that the performance representation is always in the form of a musical encoding, representing a minimal number of musical elements to subjectively yet faithfully reproduce a performance experience for listeners and performance collaborators by means of local synthesis at the point of consumption, at the receiving end. A listening experience does not preclude synchronized visualizations, also generated at the destination, from accompanying the musically encoded performances so that a complete experience would also include visual elements.

The drawing also shows two or more types of Audiences (111, 112) who require a compatible Receiver (113), implemented in software, electronic and/or mechanical hardware, or both, or any transformative implementation that can create an acoustical or visual effect in accordance with elemental musical signals produced in time via an encoding. A receiver should, but is not required to, have the ability to pass through encoded signals to an external device for rendering, plus an internal device to create an independent rendering of a performance acoustically, such as by means of local electronic synthesis and audio amplification. Such synthesis may be made partially realistic, to taste, or wildly deviant with respect to the original intentions of the performer, implying that there is no mandated correlation to the acoustic conditions of the performance that must be recreated on the receiving side. The Audience (111, 112) experience is constructed or reconstructed based on a subjective interpretation of the musical elements available in a received musical encoding. From the Output Coupling (110), an Output Converter (114) recovers music encodings as Outputs (115), possibly under instruction from a Receiver's Tuner section (116), which functions as a channel selector for one or more Outputs (115) to be rendered by the Internal Synth (117) or passed through externally (118). In one embodiment, audio amplification of the Internal Synth may be connected to Speakers (119) or Headphones (120) to complete the rendered experience for a listener.

### DETAILED DESCRIPTION OF THE INVENTION

The terminology used herein is for the purpose of describing particular embodiments only and is not intended to be limiting of the invention. The present disclosure is to be considered as an exemplification of the invention, and is not intended to limit the invention to the specific embodiments.

Unless otherwise defined, all terms (including technical and scientific terms) used herein have the same meaning as commonly understood by one having ordinary skill in the art and technology to which this invention belongs. It will be further understood that terms, such as those defined in commonly used dictionaries, should be interpreted as having a meaning that is consistent with their meaning in the context of the relevant art, technology and the present disclosure and will not be interpreted in an idealized or overly formal sense unless expressly so defined herein.

In describing the invention, it will be understood that a number of techniques and steps are disclosed. Each of these has individual benefits and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

Human communications may often occur with high information loss and still be considered effectively transmitted to a recipient, especially when the intention is subjective, interpretive or artistic. In fact, it may be demonstrated that loss of realism with respect to a conventional medium of conveyance may enhance general appreciation and enjoyment of the effect. Therefore, what may be ordinarily encoded as sound signals representing the acoustical conditions of the source environment may be instead modeled as the musical notes applied to musical instruments, including the human voice, that produce the experience at the origin. Using a musical standard of 12 tones with note “A” having a frequency of 440 hz as an common example, one reasonable model applied to a musical encoding could consist of the following parameters:
1. Events in time, including the duration, in ms or note value
2. Pitch of an event, in hz or cents
3. Timbre of an event, in db/octave or classification
4. Amplitude of an event, in db or musical dynamics
5. Vocal formant model, amplitude vs frequency map
6. Modulation of an event, including but not limited to attack and delay when applied to amplitude, filter sweep when applied to timbre and glissando when applied to pitch. Modulation parameters would likely include frequency, duration, and points or a polynomial describing influence over time
7. Additional modeling that supplements musical expression which may be expediently detected and encoded

The generation of such events could be obtained from an input device such as a musical instrument under control by manual manipulation, breath control, drum stroke or other human interaction. Such devices may include piano keyboards, wind instruments, percussion instruments, or the human voice with or without producing an ordinary acoustical effect. This event generation would be the responsibility of the performer, possibly in collaboration with others, which would imply a two-way encoding for interactivity so that any performer could synchronize at will.

The advantage of a musical encoding for broadcast communications is its large relative efficiency gain due to high information loss as compared to acoustical or visual signal modeling, especially when conveyed over electromagnetic or digitized mediums. Yet, the listener may experience a sense of higher fidelity if their expectations are musical. There is a nearly zero effective noise floor in recreating musical tones locally, near the listener, from control signals decoded by a receiver. The sense of immediacy and imagined personal presence of a performer when an instrument is under remote control may be shown to enhance immersion and appreciation by listeners. In addition, the reproduction of a decoding may be subjectively adjusted by the listener by modifying incoming parameters to taste, such as transposing a performance or changing the intended instrumentation. For some performers and composers, this system represents a unique opportunity to push the limits of current musical performance capabilities.

This invention makes no claim concerning any specific or preexisting musical encodings known in the prior art or elsewhere, only that the broadcast network utilizes this type of encoding to unique advantage. Some known musical encodings are Piano Roll, Control Voltage Gate and MIDI, but any other or proprietary encoding that models musical elements would suffice.

A modern broadcast system would consist of the following components:
1. Input channels carrying performance signals in a musical encoding, one or more inputs per performer. Input channels may originate locally and become decoupled by distance, since they will be collected centrally. The transmission of information from a performer over an input channel occurs by means of a musically-oriented input device and signal converter, such as a musical instrument controlled by the performer with sensors suitable to inform the encoding.
2. Centralized Channel Collector, or a distributed model for the same. The Channel Collector may establish internal Input and Output Channel connectivity, for the purpose of facilitating collaboration between performers or to provide a number of possible Performance selections for Audiences. The Channel Collector can make a large number of Output Channels available for recipients who form virtual audiences distributed among remote locations and decoupled from the Channel Collector by distance. Input and Output Channels may be separately coupled to the Channel Collector in any embodiment by means of wide-area digital communications, modulated electromagnetic propagation, or any other medium having sufficient bandwidth to adequately transmit timed performance signals in a musical encoding
3. Supplemental metadata to correlate Input and Output Channels, including but not limited to date, time, duration, genre, program list, titles, artist names and other descriptions of performances. The delivery and encoding of metadata is nonspecific and may be accomplished by any conventional means, such as text or hypertext. The Channel Collector may elect to respond to external requests to report this metadata and the current channel correlations.
4. The transfer of signal information from an Output Channel to a recipient occurs by means of a local realization engine coupled to the Channel Collector, such as an acoustical synthesizer or electromechanical musical instrument that is operable by the recipient but under the control of a performer while playing. This local realization engine contains a receiver that can be tuned to select any output channels being broadcast by the Channel Collector

To further enhance experience created by this broadcast system, additional musical elements may be derived from or added into an encoding without significantly impacting its overall compression ratio. For example, displays in the form of animation or augmented reality could allow visualization of a performance that accompanies the listening experience. Any or all such enhancements would follow the same principle of introducing and recovering elemental parameters into and out of the musically encoded stream.

A metaphorical familiarity with experiencing and appreciating human musical performances is inherently recreated by this system, whereby the familiar civilized entities of performers, halls, venues, theatre programs, audiences, ambiences and the sensation of a personal “presence” of a Performer are virtualized and implied by the local synthesis under remote control, requiring no physical proximity and seemingly all “at hand” to be selected for enjoyment by a Consumer.

### REFERENCES

Incorporated herein by reference:
1. “AM broadcasting”. Retrieved from https://en.wikipedia.org/wiki/AM_broadcasting.
2. “Black MIDI”. Retrieved from https://en.wikipedia.org/wiki/Black_MIDI.
3. “Cent (Music)”. Retrieved from https://en.wikipedia.org/wiki/Cent_(music).
4. “Chromatic Scale”. Retrieved from https://en.wikipedia.org/wiki/Chromatic_scale.
5. “Conlon Nancarrow”. Retrieved from https://en.wikipedia.org/wiki/Conlon_Nancarrow.
6. “CV/gate”. Retrieved from https://en.wikipedia.org/wiki/CV/gate.
7. “Drums in Communication”. Retrieved from https://en.wikipedia.org/wiki/Drums_in_communication.
8. “Duo-Art”. Retrieved from https://en.wikipedia.org/wiki/Duo-Art.
9. “Dynamics (Music)”. Retrieved from https://en.wikipedia.org/wiki/Dynamics_(music).
10. “Electrical Telegraph”. Retrieved from https://en.wikipedia.org/wiki/Electrical_telegraph.
11. “Filter (Signal Processing)”. Retrieved from https://en.wikipedia.org/wiki/Filter_(signal_processing).
12. “FM broadcasting”. Retrieved from https://en.wikipedia.org/wiki/FM_broadcasting.
13. “Formant”. Retrieved from https://en.wikipedia.org/wiki/Formant.
14. “Hyperrealism (Visual Arts)”. Retrieved from https://en.wikipedia.org/wiki/Hyperrealism_(visual_arts).
15. “Isochrony”. Retrieved from https://en.wikipedia.org/wiki/Isochrony.
16. “Kele People (Congo)”. Retrieved from https://en.wikipedia.org/wiki/Kele_people_(Congo).
17. “MIDI”. Retrieved from https://en.wikipedia.org/wiki/MIDI.
18. “Military Drums”. Retrieved from https://en.wikipedia.org/wiki/Military_drums.
19. “Note Value”. Retrieved from https://en.wikipedia.org/wiki/Note_value.
20. “NTSC”. Retrieved from https://en.wikipedia.org/wiki/NTSC.
21. “Piano roll”. Retrieved from https://en.wikipedia.org/wiki/Piano_roll.
22. “Pulse-code modulation”. Retrieved from https://en.wikipedia.org/wiki/Pulse-code_modulation.
23. “Radio”. Retrieved from https://en.wikipedia.org/wiki/Radio.
24. “Synthesizer”. Retrieved from https://en.wikipedia.org/wiki/Synthesizer.
25. “Telegraphy”. Retrieved from https://en.wikipedia.org/wiki/Telegraphy.
26. “Telephony”. Retrieved from https://en.wikipedia.org/wiki/Telephony.
27. “Television”. Retrieved from https://en.wikipedia.org/wiki/Television.
28. “Wireless Telegraphy”. Retrieved from https://en.wikipedia.org/wiki/Wireless_telegraphy.

1: The system for broadcasting musical activity through any suitable propagating medium without the continuous representation of sound or light but containing sufficient musical information to recreate performances and works for remote audiences, where the musical activity originating at the location of the performance or within the system is defined as the interactions between musicians and their instruments, including the human body as in the case of voice, that are intended to produce sound, and may be detected in real time or otherwise specified, and categorized in accordance with but not limited to the rules of music theory, which are then interpreted as sequential musical events and modeled as musical commands to be transmitted to receivers for the purpose of controlling sound generators and visual displays at the destinations, thereby recreating an artificial acoustical and visual experience for the recipients.

2: The system according to claim 1 that allows both transmit and receive capability for musical commands between performers to allow them to interoperate during a collaborative performance, even if separated by distance but connected through the invention's broadcast network.

3. (canceled)

4: The system according to claim 1 that allows a listener to identify and select a stream of musical commands from the broadcast network to control a sound generator on their receiving device, or one externally connected to it, thereby artificially recreating the selected musical experience of their choice.

5. (canceled)

6: The complete system according to claims 1, 2 and 4 whereby in one or more embodiments performers and listeners connected to the broadcast network and transmitting and receiving musical commands participate in ongoing, scheduled or replayed musical performances capable of placing listeners' devices under the direct control of the performers or the system in real time, for the purpose of generating artificial sound and images on their devices in accordance with the musical elements conveyed by the command stream, thereby providing a new form of perceptual enjoyment to a large consumer base.
